(19) United States
(12) Patent Application Publication
(10) Pub. No.: US 2015/0069688 A1
(43) Pub. Date: Mar. 12, 2015

(54) VIBRATION DAMPER FOR A MOTOR VEHICLE

(71) Applicants: Manfred SCHULER, Dittelbrunn (DE); Andreas HARTUNG, Hammelburg (DE); karin SUNDERMANN, Coesfeld (DE); Josef Renn, Dettelbach (DE); Günther HANDKE, Euerbach (DE); Manuel RUSS, Theres (DE); Peter HEUSINGER, Aidhausen (DE); Peter MALIK, Niederwerrn (DE)

(72) Inventors: Manfred SCHULER, Dittelbrunn (DE); Andreas HARTUNG, Hammelburg (DE); karin SUNDERMANN, Coesfeld (DE); Josef Renn, Dettelbach (DE); Günther HANDKE, Euerbach (DE); Manuel RUSS, Theres (DE); Peter HEUSINGER, Aidhausen (DE); Peter MALIK, Niederwerrn (DE)

(73) Assignee: ZF FRIEDRICHSHAFEN AG

(21) Appl. No.: 14/479,919

(22) Filed: Sep. 8, 2014

(30) Foreign Application Priority Data
Sep. 9, 2013 (DE) 10 2013 217 938.3

(51) Int. Cl. B60G 15/06; F16F 9/32

(52) U.S. Cl. CPC B60G 15/063; F16F 9/3235; B60G 15/062
USPC 267/221

(57) ABSTRACT

A vibration damper for a motor vehicle includes at least one cylinder tube with a longitudinal extension axis and a support spring, wherein the support spring has a first end portion and a second end portion, the support spring surrounds the cylinder tube in circumferential direction and is axially supported by the first end portion indirectly at a supporting device of the motor vehicle with respect to the longitudinal extension axis of the cylinder tube, and wherein the support spring is axially supported by its second end portion at the cylinder tube of the vibration damper. The cylinder tube has a spring disk which is formed integral with the cylinder tube, is formed out of the cylinder tube, and has a supporting surface for an end coil of the support spring.

### BACKGROUND OF THE INVENTION

1. Field of the Invention

The present invention is directed to a vibration damper for a motor vehicle with at least one cylinder tube and a support spring.

2. Description of the Related Art

DE 197 48 634 A1 discloses a vibration damper which comprises a cylinder tube and a support spring. The support spring has a first, upper end portion and a second, lower end portion. The support spring circumferentially embraces the cylinder tube and is axially supported by the upper end portion at least indirectly at a supporting device of the motor vehicle. The support spring is indirectly supported at the cylinder tube by the upper end portion. The support is effected via a separate spring disk which is fastened to the cylinder tube and which is axially supported at an annular bead formed out of the cylinder tube.

DE 198 51 484 A1 discloses a vibration damper which likewise has a cylinder tube with a longitudinal extension axis and a support spring. The support spring has a first (upper) end portion and a second (lower) end portion. The support spring circumferentially embraces the cylinder tube and is axially supported by the first end portion 3 indirectly at a supporting device of the motor vehicle. The support spring is axially supported by its second end portion at the cylinder tube of the vibration damper indirectly via a separate spring disk. The cylinder tube has an indentation in which the end coil of the support spring partially engages.

In a vibration damper of the generic type described above, the support spring is supported at a separate spring disk. The spring disk is produced as a separate component part and is fastened axially to the cylinder tube. The fastening is carried out by a bonding engagement, frictional engagement or positive engagement. In most cases, fastening by bonding engagement is carried out by welding. In so doing, the weld locations must be after-treated in view of the increased risk of corrosion. A connection by frictional engagement can be realized by means of an additional pre-loading component part which presses the spring disk against the cylinder tube. Because of the high axial loads that occur, a connection of this type connecting the spring disk to the cylinder tube of the vibration damper in a motor vehicle is used rather rarely for safety reasons.

Proceeding from the prior art described above, it is an object of the present invention to further develop a vibration damper in such a way that the above-mentioned problems are overcome in a simple and economical manner.

### SUMMARY OF THE INVENTION

This object is met according to the invention by providing a vibration damper wherein the cylinder tube has a spring disk which is formed integral with the cylinder tube, is formed out of the cylinder tube, and has a supporting surface for an end coil of the support spring.

According to an advantageous embodiment, the spring disk has a pitch portion with a pitch that is formed out corresponding to a pitch of the support spring in the region of the end coil. Accordingly, the contact surface between the support spring and the spring disk is enlarged, which counteracts the accumulation of dirt between the support spring and the spring disk. For the same reason, it is advantageous that the support spring is axially supported at the supporting surface of the spring disk via an extension in circumferential direction of at least one half of an end coil.

In an advantageous manner, the spring disk can be formed out of the cylinder tube by cold forming, for example, by hydroforming, or by widening the cylinder tube with an elastomer pressing pad. However, it is also possible to produce the spring disk by a hot forming process known to the person skilled in the art.

According to a further advantageous embodiment, the spring disk can have an anti-torsion arrangement which prevents torsion of the end coil of the support spring relative to the spring disk. This anti-torsion arrangement can be formed out of the cylinder tube together with the spring disk during the production of the spring disk.

### BRIEF DESCRIPTION OF THE DRAWINGS

Further details and advantages of the present invention are given in the following description of an exemplary embodiment in combination with the drawings in which:

FIG. 1 is an exemplary perspective view of a spring disk which is formed out of a cylinder tube and has a support spring, according to the present invention;

FIG. 2 is a sectional view according to FIG. 1;

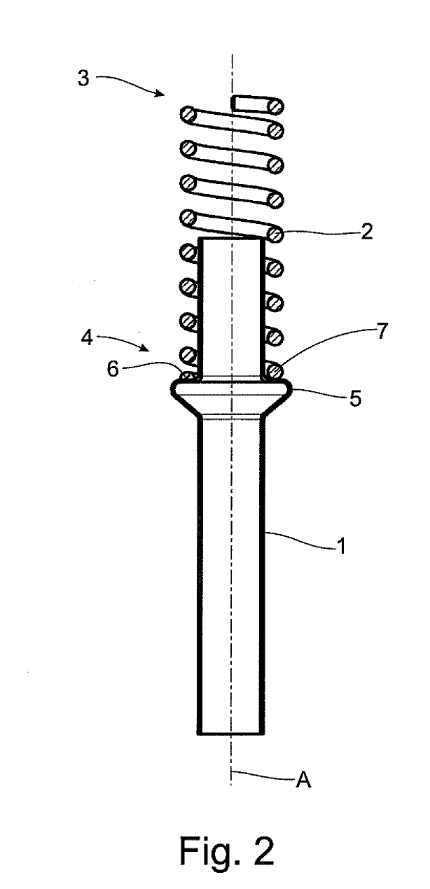

FIG. 3 is an exemplary perspective view of a further embodiment of a spring disk which is formed out of a cylinder tube and has a support spring, according to the present invention; and

FIG. 4 is a sectional view according to FIG. 3.

### DETAILED DESCRIPTION OF THE PRESENTLY PREFERRED EMBODIMENTS

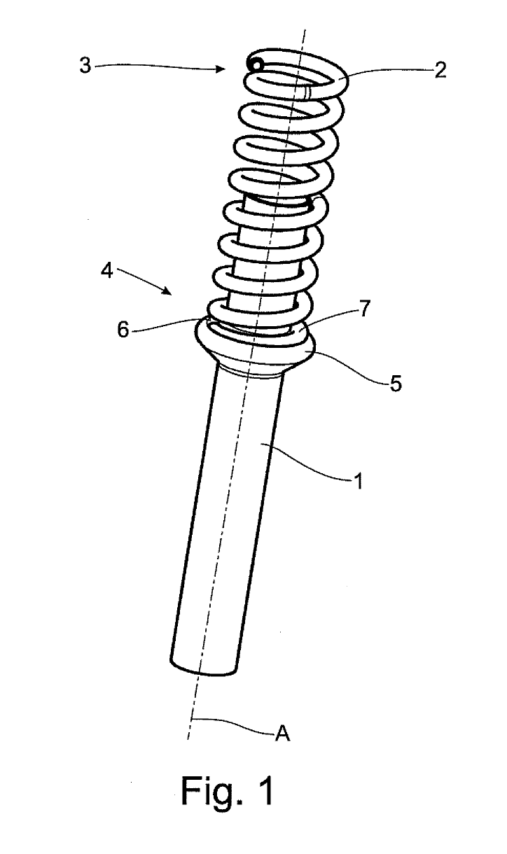

FIG. 1 shows a cylinder tube 1 of a vibration damper for a motor vehicle with a longitudinal extension axis A and a support spring 2. The support spring 2 surrounds the cylinder tube 1 in circumferential direction. The support spring 2 has a first end portion 3 and a second end portion 4 and is axially supported by first end portion 3 at a supporting device, not shown, of a motor vehicle at least indirectly with reference to the longitudinal extension axis A of cylinder tube 1. The support spring 2 is axially supported by second end portion 4 at cylinder tube 1 of the vibration damper.

Further, all of the figures show that cylinder tube 1 has a spring disk 5 which is formed integral with cylinder tube 1, is formed out of cylinder tube 1, and has a supporting surface 6 for an end coil 7 of support spring 2. The spring disk 5 can be formed out of cylinder tube 1 by cold forming or by hot forming.

Accordingly, support spring 2 is supported directly at the spring disk 5 which is formed out of the cylinder tube 1. Since the cylinder tube 1 could be provided with a corrosion-resistant layer, a spring pad, not shown, which is produced from an elastic material can be used, and this spring pad can be arranged between the support spring and the spring disk for the purpose of protecting the corrosion-resistant layer arranged at spring disk 5 and/or at support spring 2 against abrasion.

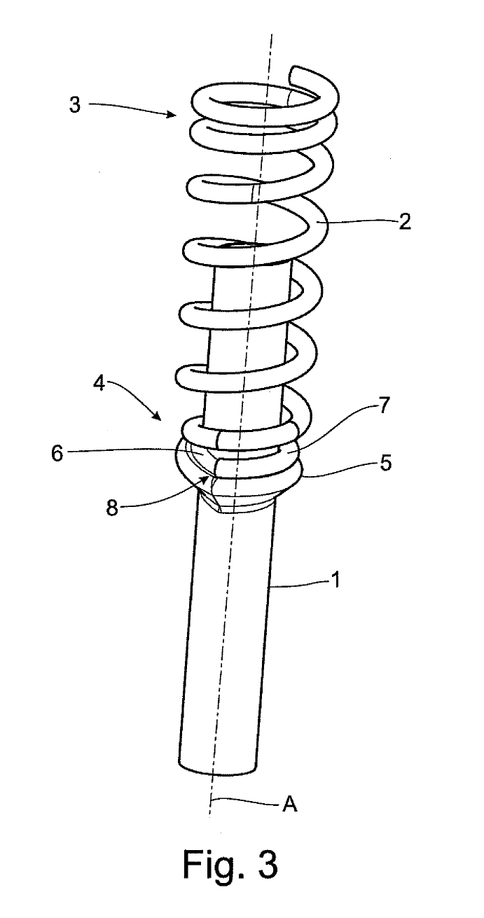

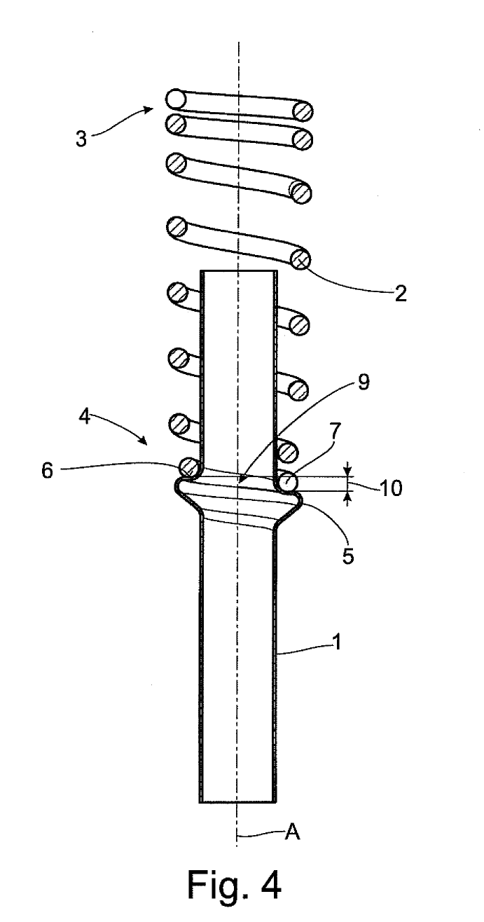

FIGS. 3 and 4 in particular show that spring disk 5 can have a pitch portion 9 with a pitch 10 which is formed out corresponding to a pitch of support spring 2 in the region of end coil 7. FIG. 3 further shows that support spring 2 is axially supported at supporting surface 6 of spring disk 5 via an extension in circumferential direction of at least one half of end coil 7. Accordingly, the contact surface between support spring 2 and spring disk 5 is defined such that accumulation of dirt between support spring 2 and spring disk 5 is counteracted on one hand, but that, given a predefined spring path, support spring 2 is utilized to the maximum possible extent on the other hand.

It can further be seen from FIG. 3 and FIG. 4 that spring disk 5 has an anti-torsion arrangement 8 which opposes torsion of end coil 7 of support spring 2 relative to spring disk 5. This anti-torsion arrangement 8 can be formed out of cylinder tube 1 together with the spring disk as is shown in FIG. 3 and FIG. 4.

It can be seen from all of the figures that cylinder tube 1 has an enlarged volume in the region of spring disk 5. Depending on the constructional configuration of the vibration damper, this enlarged volume can be used as additional volume for a gas space in a single-tube vibration damper or as a gas space and/or oil space in a two-tube vibration damper.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. Vibration damper for a motor vehicle comprising:
at least one cylinder tube (1) having a longitudinal extension axis (A);
a support spring (2) having a first end portion (3) and a second end portion (4), said supporting spring (2) having an end coil (7) and surrounding said cylinder tube (1) in circumferential direction and axially supported by said first end portion (3) indirectly at a supporting device of the motor vehicle with respect to said longitudinal extension axis (A) of said cylinder tube (1), said support spring (2) being axially supported by its second end portion (4) at said cylinder tube (1) of the vibration damper;
said cylinder tube (1) having a spring disk (5) formed integral with said cylinder tube (1), and formed out of said cylinder tube (1), and said spring disc having a supporting surface (6) for said end coil (7) of said support spring (2).

2. The vibration damper for a motor vehicle according to claim 1, wherein said spring disk (5) has a pitch portion (9) with a pitch (10) formed out corresponding to a pitch of said support spring (2) in the region of said end coil (7).

3. The vibration damper for a motor vehicle according to claim 1, wherein said support spring (2) is axially supported at said supporting surface (6) of said spring disk (5) via an extension in circumferential direction of at least one half of said end coil (7).

4. The vibration damper for a motor vehicle according to claim 1, wherein said spring disk (5) has an anti-torsion arrangement (8) which opposes a torsion of said end coil (7) of said support spring (2) relative to said spring disk (5).

5. The vibration damper for a motor vehicle according to claim 1, wherein said spring disk (5) is formed out of said cylinder tube (1) by cold forming.

6. The vibration damper for a motor vehicle according to claim 1, wherein said spring disk (5) is formed out of said cylinder tube (1) by hot forming.
